(19) United States
(12) Patent Application Publication
(10) Pub. No.: US 2026/0034902 A1
(43) Pub. Date: Feb. 5, 2026

(54) RECOVERY ELECTRICAL VEHICLE SUPPLY EQUIPMENT

(71) Applicant: Rivian IP Holdings, LLC, Irvine, CA (US)

(72) Inventors: Frederik Francois BOTES, Ontario, CA (US); Ramachandra VANNALA, Fremont, CA (US); Sanjeewa Keven SUGATAPALA, Long Beach, CA (US); Baojin WANG, San Marcos, CA (US); Wendy Wai-Lan SIU, Torrance, CA (US); Tyler Jennings BENNETT, Long Beach, CA (US); Srinivasa Sastry GUNTUR, Charlotte, NC (US)

(21) Appl. No.: 18/793,202

(22) Filed: Aug. 2, 2024

(51) Int. Cl. B60L 53/16; B60L 53/53; B60L 53/66; H02J 7/00

(52) U.S. Cl. CPC B60L 53/16; B60L 53/53; B60L 53/66; H02J 7/00034; H02J 7/0047; B60L 2210/14; H02J 2207/20

(57) ABSTRACT

A recovery electrical vehicle supply equipment (EVSE) may provide a low voltage via the proximity pilot pin in order to wake the battery management system (BMS) and provide contactor power to the necessary contactors. In an example, the BMS may wake to enable the recovery EVSE to provide high voltage direct current (HVDC) power to the energy storage system (ESS). Once the ESS is charged enough to self-sustain contactors and a charging session, the BMS may then enable the on-board low voltage (LV) system to start a charging session.

### INTRODUCTION

The present disclosure relates to electric vehicle (EV) charging hardware. With widespread use of electric vehicles comes greater need for charging resources and standardization. Electric vehicle supply equipment (EVSE) is one standard used for vehicle charging equipment. A high voltage battery of an EV may be connected with the EVSE to facilitate the transfer of electrical energy from a power source, such as the power grid, to a high voltage battery of the EV. EVSEs are designed to detect power connection issues and immediately cut-off power for safety reasons.

### SUMMARY

This disclosure is generally directed to a recovery electric vehicle supply equipment (EVSE) and a recovery circuit associated with the battery management system (BMS). A recovery EVSE may provide a low voltage via the proximity pilot pin in order to wake the BMS and provide contactor power to the necessary contactors. In an example, the BMS may wake to enable the recovery EVSE to provide high voltage direct current (HVDC) power to the energy storage system (ESS). Once the ESS is charged enough to self-sustain contactors and a charging session, the BMS may then enable the on-board LV system to start a charging session.

In accordance with one or more aspects of the disclosure, one or more apparatuses may include a controller module, a high voltage direct current (HVDC) power module, and a recovery low voltage power module communicatively connected with the controller, wherein the recover low voltage power module transmits low voltage power over a pin corresponding to the proximity pilot pin for an electric vehicle. The one or more apparatuses may include an EVSE, an adapter to an EVSE, or an adapter to an electric vehicle.

In accordance with one or more aspects of the disclosure, one or more apparatuses may include a recovery circuit module that accepts low voltage power for charging over a pin, wherein the low voltage power for charging and proximity pilot signals are transmitted over the pin at different periods; and a battery management system (BMS), wherein the recovery circuit module activates the BMS when the BMS is disabled due to lack of power. The one or more apparatuses may include an electric vehicle or HV battery subsystem.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example block diagram of a vehicle recovery system.

FIG. 2 illustrates an example block diagram of a vehicle recovery system.

FIG. 3 illustrates an example method of a vehicle recovery system.

FIG. 4 illustrates an example method of a vehicle recovery system.

FIG. 5A illustrates an example overhead view of a vehicle with zonal power distribution as described herein.

FIG. 5B illustrates an example side view of a vehicle with zonal power distribution as described herein.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

In order to make electric vehicles (EVs) more profitable, material cost may be reduced by removing components such as the use of a low voltage (LV) battery. The LV battery can be feasibly removed from an EV and the EV may then be powered by just a high voltage (HV) battery (with a low voltage subsystem that converts the HV power). However, since the HV battery also powers LV systems in conventional EVs, when the HV battery charge is reduced to a critical low level, recovering an EV may be difficult.

In an example scenario, when a high voltage (HV) battery (and 12V battery) is depleted, there may be a need to separately jumpstart the LV battery (e.g., 12V battery) as well as connecting an EVSE to a the HVDC power supply through the charging port of an electric vehicle. In this example scenario, there may be a need to have two separate charging connections made to awaken the electric vehicle with the totally depleted power supply. Therefore, jumpstarting an electric vehicle may be more complex than standard combustion engine vehicles. The disclosed subject matter may allow for jumpstarting a vehicle using a single connection via the charging port and reduce the need for components, such as a jumpstart harness, mounting, or the like.

This disclosure is generally directed to a recovery (e.g., jumpstart) electrical vehicle supply equipment (EVSE) as well as a recovery circuit associated with the battery management system (BMS). A recovery EVSE may provide a low voltage (e.g., 10V-14V volts) via the proximity pilot pin in order to wake the BMS and provide contactor power to the necessary contactors. The BMS may wake via a recovery circuit within the electric vehicle and the BMS may enter into a recovery charging mode in which the BMS commands the contactors closed (following necessary pre-checks) to enable the recovery EVSE to provide high voltage direct current (HVDC) power to the energy storage system (ESS). Once the ESS is charged enough to self-sustain contactors and a charging session, the BMS may then enable the on-board LV system to start a charging session.

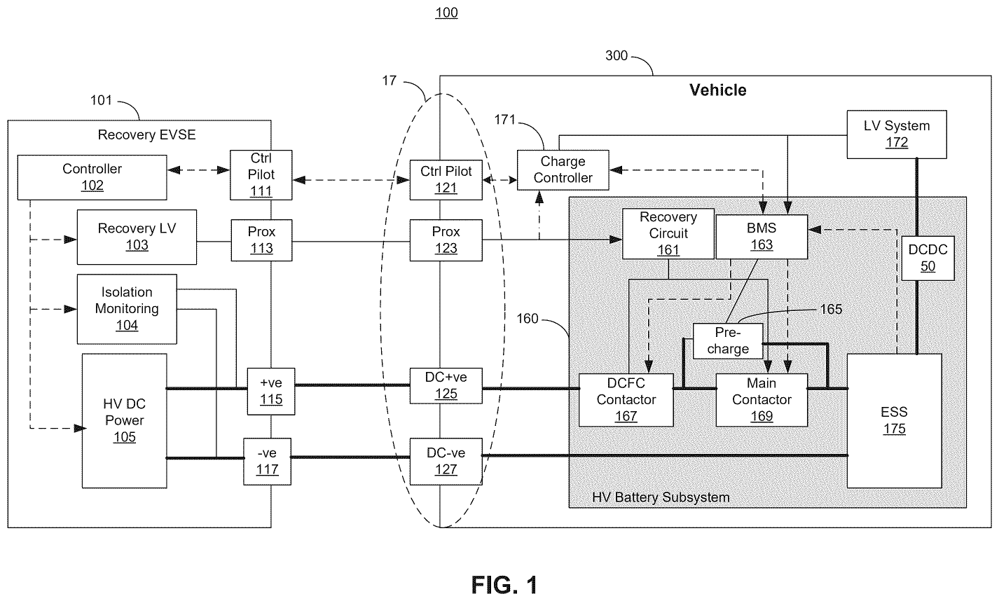

FIG. 1 illustrates an exemplary block diagram of an EV recovery system 100. EV recovery system 100 may include recovery EVSE 101 and vehicle 300. Recovery EVSE 101 may include controller module 102, recovery LV power module 103, isolation monitoring module 104, or HVDC power module 105. Each module may be communicatively connected with each other. Control pilot pin 111 may be connected with controller module 102 and proximity pilot pin 113 may be connected with recovery LV power module 103. Isolation monitoring module 104 and HVDC power module 105 may be connected with positive pin 115 and negative pin 117, as shown. Isolation monitoring module 104 may measure or manage the isolation of the electrical system. Isolation monitoring module 104 may be a circuit that has access to unswitched HV or switched HV. The circuit, when activated, may insert different test isolation resistance periodically and measure the voltage changes, therefore the vehicle or pack isolation resistance may be calculated.

Controller module 102 may communicate instructions to each of the modules, such as activating HVDC power module 105 to transmit HVDC power over pins or activate recovery LV power module 103 to send different voltages (e.g., 12V during recovery and 5V during charging). Recovery LV power module 103 may enable proximity pilot pin 113 to send LVs (e.g., approximately 12V), which may be during recovery (e.g., depletion of most or all of battery-jumpstart), for supplying power to active or more components of vehicle 300. At a separate time, recovery LV power module 103 may supply 5V or the like voltage during conventional charging. When vehicle 300 receives 5V on proximity pilot pin 123 (from proximity pilot pin 113), this may be an indication to electric vehicle 300 that a connection is engaged with it. Because proximity pilot pin 113 may be used with multiple voltages (e.g., 5V or 12V), there may be additional functionality without the need to add additional pins (e.g., connectors). It is contemplated that an extra pin may be dedicated to recovery on recovery EVSE 101 or vehicle 300.

Charging port 17 of vehicle 300 may include control pilot pin 121, proximity pilot pin 123, positive pin 125, or positive pin 127, among others. Such pins may be used to connect with control pilot pin 111, proximity pilot pin 113, positive pin 115, or negative pin 117 of recovery EVSE 101.

Vehicle 300 may include charge controller module 171, LV system 172, DCDC 50, energy storage system (ESS) 175, recovery circuit 161, battery management system (BMS) 163, pre-charge 165, direct current fast charger (DCFC) contactor 167, or main contactor 169. Charge controller module 171 may enable input protection when there is a detected voltage higher than a threshold voltage (e.g., 10V or higher) supplied through proximity pilot pin 123. Traditional operation of charge controller module 171 may occur when ESS 175 reaches a charging threshold.

Recovery circuit 161 is a circuit that may engage when an approximate 12Vs (e.g., 9V to 16V) is supplied through proximity pilot pin 123. Recovery circuit 161 may wake up BMS 163 by supplying power to it, which may be because no power is available due to a near total depletion of battery power. Recovery circuit 161, in addition to supplying power to BMS 163, may supply LV power to other components. Recovery circuit 161 may power the contactors (directly to the contactor driving circuits or give enough power to the BMS 163 to power the contactor driving circuits). Recovery circuit 161 may power charge controller module 171. In an alternative, an on board charger to power to allow alternating current (AC) charging, which may require significantly more power and current. Recovery circuit 161 may be disabled when there is a threshold charge supplied to ESS 175. In an example, when ESS 175 is charged enough to self-sustain contactors and a charging session, BMS 163 may then enable the on-board LV system 172 to start a charging session.

BMS 163 may generally be used to optimize the performance of the battery pack by monitoring or regulating parameters such as voltage, current, or temperature. BMS 163 may extend the battery life by implementing functions like cell balancing or control over charging and discharging processes.

BMS 163 when in recovery mode may close pre-charge 165, DCFC contactor 167, or main contactor 169 to enable power to flow to ESS 175 from HVDC power module 105. Main contactor may be a component that may be used to define/direct whether any HV may be imported or exported from ESS 175. ESS 175 refers to the battery and other components that enable the storage of electrical energy for later use. When enough charge (e.g., a threshold charge such as 15 min of charge, a threshold of 1% charge, or a threshold of 0.5 kilowatt hour) is supplied to ESS 175, BMS 163 may end the recovery charging session. In addition, when enough charge is provided to ESS 175, then LV system 172 may be enabled.

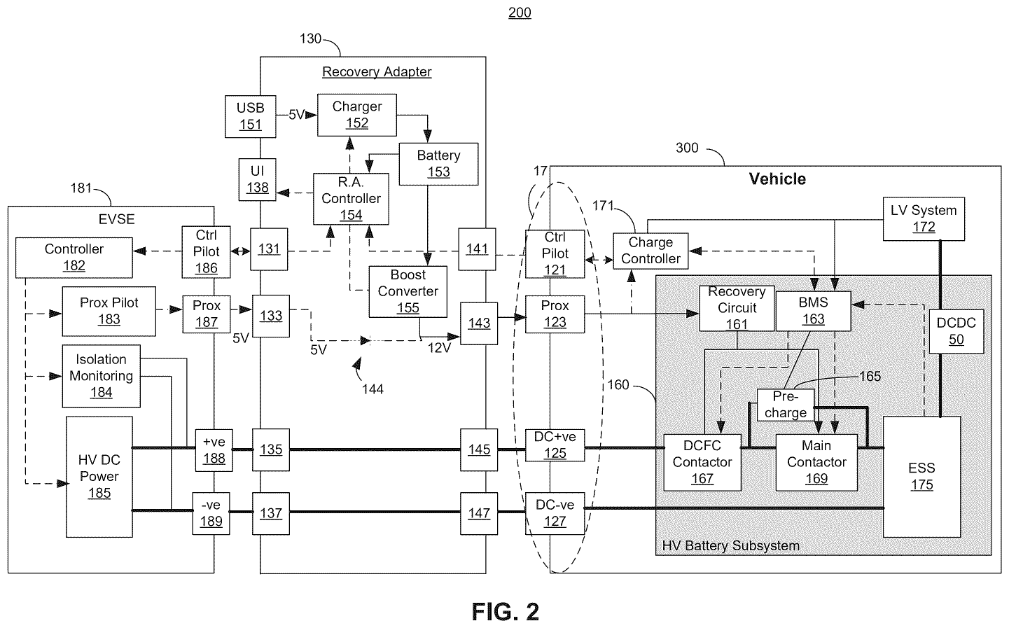

FIG. 2 illustrates an exemplary block diagram of an EV recovery system 200. EV recovery system 200 may include EVSE 181, recovery adapter 130, or vehicle 300. Recovery adapter 130 may be removably coupled or fixed with a connector of EVSE 181 or port of vehicle 300 using the pins as shown, which may be similar to pins associated with SAE J1772 or SAE J3400.

EVSE 181 may include controller module 182, proximity pilot module 183, isolation monitoring module 184, or HVDC power module 185. Each module may be communicatively connected with each other. Control pilot pin 186 may be connected with controller module 182 and proximity pilot pin 187 may be connected with proximity pilot module 183. Isolation monitoring module 184 and HVDC power module 185 may be connected with positive pin 188 and negative pin 189, as shown.

Positive pin 188 (e.g., DC+/L1) may provide the positive side of the DC voltage link. Negative pin 189 (e.g., DC−/L2) may provide the negative side of the DC voltage link. Control pilot pin 186 may be a communication line used to initiate charging, negotiate charging level between vehicle 300 and EVSE 181, or carry other information.

Controller module 182 may communicate instructions to each of the modules, such as activating HVDC power module 185 to transmit HVDC power over pins or activate proximity pilot module 183 to send 5V. When vehicle 300 receives 5V on proximity pilot pin 123 (from proximity pilot pin 143, which is connected with proximity pilot pin 133 and proximity pilot pin 187), this may be an indication to EV 300 that a connection is engaged with it. Proximity pilot pin 187 may carry a signal to the control system of vehicle 300 that may prevent movement while connected to EVSE 181.

Charging port 17 of vehicle 300 may include control pilot pin 121, proximity pilot pin 123, positive pin 125, or positive pin 127. Such pins may be used to connect with control pilot pin 141, proximity pilot pin 143, positive pin 145, or negative pin 147 of recovery adapter 130.

Recovery adapter 130 may include universal serial bus (USB) port 151, battery charger module 152, rechargeable battery module 153, recovery adapter controller module 154, boost converter module 155, user interface (UI) module 138, control pilot pin 131, control pilot pin 141, proximity pilot pin 133, proximity pilot pin 143, diode 144 (or the like operation), positive pin 135, positive pin 145, negative pin 137, or negative pin 147. Each module may be communicatively connected with each other.

USB port 151 may be connected with battery charger module 152. USB port 151 may be externally connected with a power source and may be used to send power to battery charger module 152 in order to charge rechargeable battery module 153. UI module 138 may allow a user to input control commands to the recovery adapter controller module 154 or may allow the recovery adapter controller module 154 to provide status feedback to the user.

With reference to boost converter module 155, if rechargeable battery module 153 is of a lower voltage level, such as 3V or 5V, boost converter module 155 may convert the lower voltage level to a higher voltage level (e.g., 12V) needed to power recovery circuit 161 over proximity pilot pin 143. If rechargeable battery module 153 is already at the higher voltage level, then boost converter 1 module 55 may not be needed.

Rechargeable battery module 153 may include a LV battery (e.g., approximately 5V-14V) and provide power to boost converter module 155. In addition, rechargeable battery module 153 may power to recovery adapter controller module 154 or other electronic controls (e.g., UI module 138). Boost converter module 155 may be used to transmit a LV (e.g., 10V-14V) to proximity pilot pin 143 for executing a recovery LV power process. Boost converter module 155 may increase input voltage from a source to provide a higher output voltage. Proximity pilot pin 143 may be connected with boost converter module 155 or proximity pilot pin 133. Diode 144 (or the like functionality) may be added as shown to protect proximity pilot pin 187 or (proximity pilot pin 133) from voltages that it is not designed for (e.g., exceeds 6Vs). Diode 144 may be 0.5 mm to 1.2 mm. Diode 144 may not need to carry much current in the forward direction (e.g., normal 5V from proximity pilot pin 187) but diode 144 may need to protect against 16V-24V+ in the reverse direction. It is contemplated for a 48V architecture, diode 144 may be 2.5 mm, which may protect against higher voltage (between 6V and 60V).

Recovery adapter controller module 154 may communicate with or be connected with battery charger module 152, boost converter module 155, UI 138 (e.g., display information or receive information), control pilot pin 131, or control pilot pin 141. Recovery adapter controller module 154 may initiate or otherwise manage a charge session with EVSE 181 and vehicle 300, which may be based on intercepting or generating control messages. Recovery adapter controller module 154 may control charging of the rechargeable battery module 153, control the boost converter module 155 setpoint voltage, communicate with EVSE 181 over control pilot pin 186, communicate with vehicle 300 over control pilot pin 121, provide feedback to the user using UI 138, or allow the user to operate/control the recovery adapter 130 using UI 138.

In an example, recovery adapter controller module 154 may send a message to controller module 182 via control pilot pin 131 to transmit or refrain from transmitting power via HVDC power module 185 based on one or more factors, such as an indicated level of charge or availability of charge from vehicle 300. Positive pin 135, positive pin 145, negative pin 137, or negative pin 147 may be connected as a passthrough between EVSE 181 and vehicle 300, in which the control of charging may be based on signaling to controller module 182, BMS 163, or the like.

Similarly, as shown in FIG. 1, vehicle 300 may include charge controller module 171, LV system 172, DCDC 50, energy storage system 175, recovery circuit 161, battery management system (BMS) 163, pre-charge 165, DCFC contactor 167, or main contactor 169. Charge controller module 171 may be enable input protection when voltage higher than a threshold voltage (e.g., 10V to 14V) is supplied through proximity pilot pin 143. Traditional operation of charge controller module 171 may occur when ESS 175 reaches a charging threshold.

Recovery circuit 161 is a circuit that may engage when an approximate 12Vs is supplied through proximity pilot pin 143. Recovery circuit 161 may wake up BMS 163 by supplying power to it, which may be because no power is available due to a near total depletion of battery power. Recovery circuit 161, in addition to supplying power to BMS 163, may supply LV power to other components. Recovery circuit 161 may be disabled when there is a threshold charge supplied to ESS 175.

BMS 163 may generally be used to optimize the performance of the battery pack by monitoring or regulating parameters such as voltage, current, or temperature. BMS 163 may extend the battery life by implementing functions like cell balancing or control over charging and discharging processes.

BMS 163 when in recovery mode may close pre-charge 165, DCFC contactor 167, or main contactor 169 to enable power to flow to ESS 175 from HVDC power module 105. ESS 175 refers to the battery and other components that enable the storage of electrical energy for later use. When enough charge (e.g., a threshold charge such as 15 min of charge) is supplied to ESS 175, BMS 163 may end recovery charging session. In addition, when enough charge is provided to ESS 175, then LV system 172 may be enabled.

For additional perspective, there may be a 48V architecture in the vehicle 300 (e.g., in truck). If so, there may be a 48V version of the recovery adapter 130, in which boost converter module 155 provides a higher voltage at a lower current (which may actually be advantageous to supply more power to vehicle 300 for the same size wiring on proximity pilot pin 123). It is contemplated that there may be a variable voltage output using boost converter module 155 to be compatible with multiple different vehicle LV power architectures. Note 9V-16V may be the nominal range for a 12V system, but a 48V architecture may have a different range.

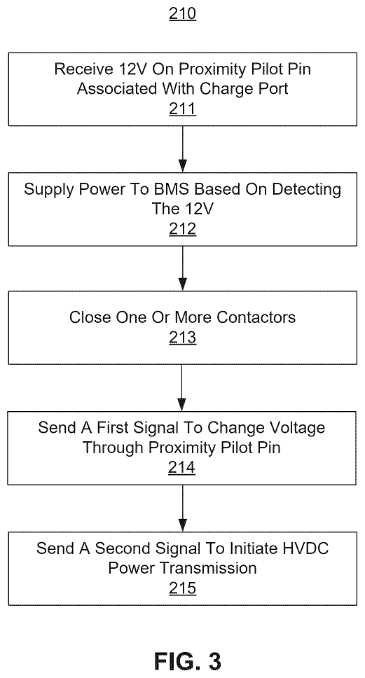

FIG. 3 illustrates an exemplary method 210 associated with recovery (e.g., jumpstarting) of an electric vehicle. At block 211, an approximate 12V power transmission may be received on proximity pilot pin 123 of vehicle 300.

At block 212, recovery circuit 161 may provide power to BMS 163, DCFC contactor 167, pre-charge 165, or main contactor 169 based on detecting a 12V power transmission of block 211. The 12V power transmission may supply the power for enabling BMS 163 as well as other LV components. Recovery circuit 161 may be automatically activated when the 12V power transmission is detected.

At block 213, BMS 163 may automatically close one or more of the contactors to enable HVDC power to be transmitted to ESS 175. Recovery circuit 161 may continue supplying power to BMS 163, DCFC contactor 167, pre-charge 165, or main contactor 169 until an indication is received that ESS 175 has reached a threshold level of charge.

At block 214, a first signal may be sent to control pilot pin 121. The first signal may be an indication for changing the voltage sent through proximity pilot pin 113. In an example, the first signal may be an indication that EVSE 181 change from a 12V to a 5V transmission (e.g., 5V may be received instead of 12V) through proximity pilot pin 113.

At block 215, a second signal may be sent to control pilot pin 121. The second signal may indicate that recovery EVSE 101 transmit HV DC power. Vehicle 300 may receive HVDC power based on the second signal and therefore ESS 175 may be charged.

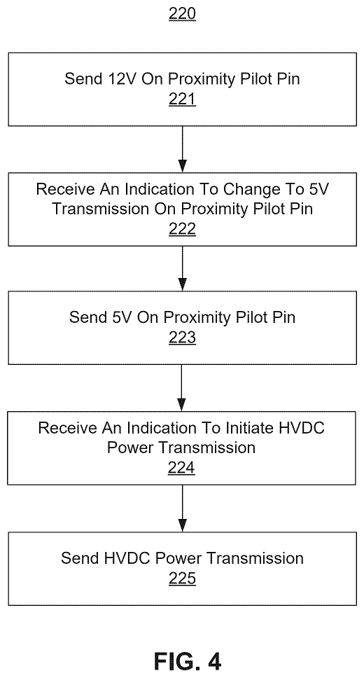

FIG. 4 illustrates an exemplary method 220 associated with jumpstarting an electric vehicle. At block 221, an approximate 12V power transmission may be transmitted on proximity pilot pin 113 of vehicle 300. Recovery LV power module 103 may transmit the approximate 12V power transmission. Recovery LV power module 103 may be configured to send approximately 5V, approximately 12V, or another voltage. At block 222, subsequent to or based on transmitting the approximate 12V power, an indication may be received on control pilot pin 111 to transmit 5V on the proximity pilot pin 113. At block 223, a 5V transmission may be sent on proximity pilot pin 113 instead of 12V or similar (e.g., 9V-16V) transmission.

At block 224, based on or subsequent to transmitting the 5V power transmission, an indication to transmit HVDC power via HVDC power module 105 may be received. The indication to transmit HVDC power (e.g., message) may be sent by controller module 102 in response to control information from vehicle 300 indicating the same. At block 225, HVDC power may be transmitted via HVDC power module 105 (or HVDC power module 185), based on the indication of block 224.

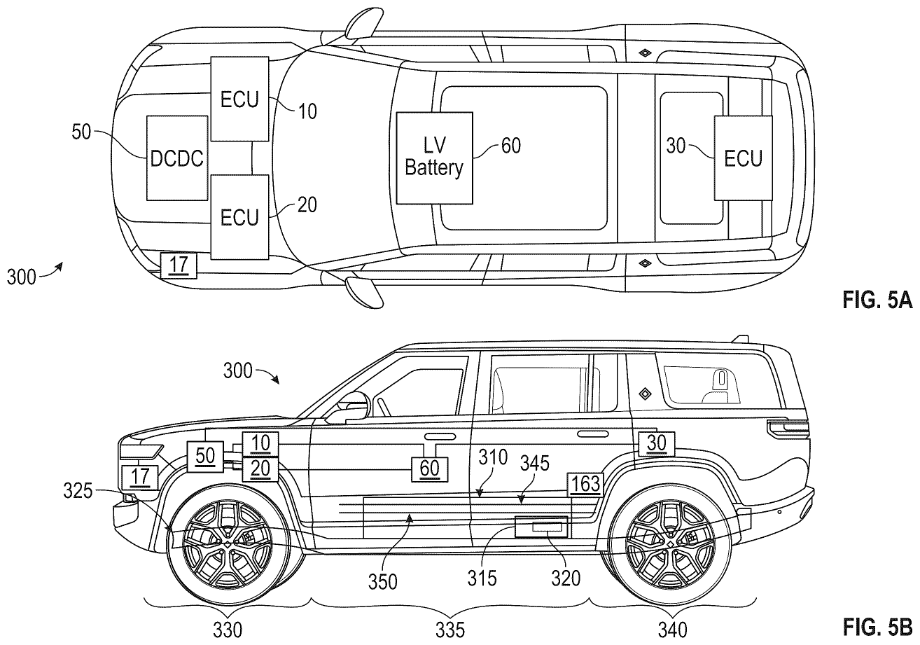

FIG. 5A illustrates an exemplary overhead view of vehicle 300. As further described herein, vehicle 300 may include electronic control units (ECUs) in front portion 330 of vehicle 300 (e.g., ECU 10 and ECU 20), an ECU in rear portion 340 of vehicle 300 (e.g., ECU 30), direct current to direct current converter (DCDC) 50, low voltage (LV) battery 60 (e.g., 12V battery), or charging port 17, among other things. Recovery EVSE 101 or recovery adapter 130 may connect with charging port 17.

FIG. 5B illustrates an exemplary side view of vehicle 300. As shown, the vehicle 300 may include one or more battery packs, such as high voltage (HV) battery pack 310 (e.g., 450V), which may be located near the center body portion 335 of vehicle 300. HV battery pack 310 may be coupled with one or more electrical systems of the vehicle 300 to provide power to the electrical systems. ECU 10, ECU 20, or ECU 30 may be communicatively connected with or have power distributed with each other and may be functionally redundant for power or other operations of electronic components of vehicle 300.

In one or more implementations, the vehicle 300 may be an electric vehicle having one or more electric motors that drive the wheels 302 of the vehicle using electric power from HV battery pack 310. In one or more implementations, the vehicle 300 may also, or alternatively, include one or more chemically-powered engines, such as a gas-powered engine or a fuel cell powered motor. For example, electric vehicles can be fully electric or partially electric (e.g., hybrid or plug-in hybrid). In various implementations, the vehicle 300 may be a fully autonomous vehicle that can navigate roadways without a human operator or driver, a partially autonomous vehicle that can navigate some roadways without a human operator or driver or that can navigate roadways with the supervision of a human operator, may be an unmanned vehicle that can navigate roadways or other pathways without any human occupants, or may be a human operated (non-autonomous) vehicle configured for a human operator.

In the example of FIG. 5B, the vehicle 300 may be implemented as a truck (e.g., a pickup truck) having HV battery pack 310. As shown, HV battery pack 310 may include on or more battery modules 315, which may include one or more battery cells 320. However, this is merely illustrative and, in other implementations, HV battery pack 310 may be provided without any battery modules 315 (e.g., in a cell-to-pack configuration).

As shown in FIG. 5B, the vehicle 300 may include a support structure such as a chassis 325 (e.g., a frame, internal frame, or other support structure). The chassis 325 may support various components of the vehicle 300. As shown, the chassis 325 may span a front portion 330 (e.g., a hood or bonnet portion), center body portion 335, and a rear portion 340 (e.g., a trunk, payload, or boot portion) of the vehicle 300 in some implementations. In one or more implementations, HV battery pack 310 may be installed on the chassis 325 (e.g., within one or more of the front portion 330, center body portion 335, or the rear portion 340). As shown, HV battery pack 310 may include or be electrically coupled with one or more one busbars (e.g., one or more current collector elements). In the example of FIG. 5B, the vehicle 300 includes a first busbar 345 and a second busbar 350, either or both of which may include electrically conductive material to connect or otherwise electrically couple the battery module(s) 315 or the battery cell(s) 320 with other electrical components of the vehicle 300 to provide electrical power to various systems or components of the vehicle 300.

Vehicle 300 may include a battery management system (BMS) 163. BMS 163 may be located at or near HV battery pack 310, which a LV system (e.g., LV system 172 of FIG. 1) converts the HV DC to a lower voltage, such as 12V. LV system 172 may help reduce the need for LV battery 60. It is contemplated that functions of vehicle 300 may be powered by one or more of the disclosed power sources.

In other implementations, the vehicle 300 may implemented as another type of electric truck, an electric delivery van, an electric automobile, an electric car, an electric motorcycle, an electric scooter, an electric passenger vehicle, an electric passenger or commercial truck, a hybrid vehicle, or other vehicles such as sea or air transport vehicles, planes, helicopters, submarines, boats, or drones, and/or any other movable apparatus having a HV battery pack 310 (e.g., that powers the propulsion or drive components of the moveable apparatus). It is also contemplated herein that other than 12V the LV range may be 9V-16V.

The methods, systems, computer readable storage medium, or apparatuses disclosed herein may be incorporated into electric vehicles or other devices. An apparatus may include a controller module; a recovery low voltage power module communicatively connected with the controller, wherein the recover low voltage power module transmits low voltage power over a pin corresponding to the proximity pilot pin for an electric vehicle; and one or more connections configured to transmit high voltage direct current (HVDC) power. The controller may be configured to communicate instructions to the recovery low voltage power module to transmit low voltage power for charging and transmit proximity pilot signals over a pin at different periods. The apparatus may be an electrical vehicle supply equipment (EVSE). The apparatus may be an adapter to an electrical vehicle supply equipment (EVSE) or electric vehicle. The methods, systems, or apparatuses disclosed herein may be incorporated into products, such as various feature specific or zone specific electronic control units (ECUs).

The one or more apparatuses may include a recovery circuit module that accepts low voltage power for charging over a pin, wherein the low voltage power for charging and proximity pilot signals are transmitted over the pin at different periods; and a battery management system (BMS), wherein the recovery circuit module activates the BMS when the BMS is disabled due to lack of power. The one or more apparatuses may include an electric vehicle or HV battery subsystem. The BMS may be configured to enter into a recovery charging mode when activated by the recovery circuit module. The BMS may send instructions (e.g., a control command) during the recovery charging mode the closing of contactors to enable a recovery electrical vehicle supply equipment (EVSE) to provide high voltage direct current (HVDC) power to an energy storage system (ESS) of the vehicle. The control command may be communicated via a charge controller. The recovery circuit module may be configured to provide power to a DCFC contactor or main contactor. All combinations (including the removal or addition of steps) in this paragraph and the previous paragraphs are contemplated in a manner that is consistent with the other portions of the detailed description.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C. In addition, the use of the word “or” is generally used inclusively unless otherwise provided herein.

When an element is referred to herein as being “connected” or “coupled” to another element, it is to be understood that the elements can be directly connected to the other element or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. An apparatus comprising:
a controller module;
a recovery low voltage power module communicatively connected with the controller module, wherein the recovery low voltage power module transmits low voltage power over a pin corresponding to a proximity pilot pin for an electric vehicle; and
a high voltage direct current (HVDC) power module configured to provide HVDC power.

2. The apparatus of claim 1, wherein the controller module is configured to communicate instructions to the recovery low voltage power module to transmit low voltage power for charging and proximity pilot signals over the pin at different periods.

3. The apparatus of claim 1, wherein the low voltage power is approximately 12 volts.

4. The apparatus of claim 1, wherein the apparatus is an electrical vehicle supply equipment (EVSE).

5. The apparatus of claim 1, wherein the apparatus is an adapter configured to couple with an electrical vehicle supply equipment (EVSE).

6. The apparatus of claim 1, wherein the apparatus is an adapter configured to couple with the electric vehicle.

7. The apparatus of claim 1, wherein the apparatus is an adapter configured to couple with an electrical vehicle supply equipment (EVSE), wherein the adapter further comprises a boost converter module.

8. The apparatus of claim 1, wherein the apparatus is an adapter configured to couple with an electrical vehicle supply equipment (EVSE), wherein the adapter further comprises a battery charger module for charging a rechargeable battery.

9. The apparatus of claim 1, wherein the apparatus is an adapter configured to couple with an electrical vehicle supply equipment (EVSE), wherein the adapter further comprises a rechargeable battery.

10. The apparatus of claim 1, wherein the apparatus is an adapter configured to couple with an electrical vehicle supply equipment (EVSE), wherein the adapter further comprises a diode between a first proximity pilot pin and a second proximity pilot pin.

11. The apparatus of claim 1, wherein the apparatus is an adapter configured to couple with an electrical vehicle supply equipment (EVSE), wherein the adapter further comprises a first proximity pilot pin and a second proximity pilot pin.

12. A vehicle comprising:
a recovery circuit module that accepts is configured to receive low voltage power for charging over a pin, wherein the pin receives the low voltage power for charging and proximity pilot signals at different periods; and
a battery management system (BMS), wherein the recovery circuit module activates the BMS when the BMS is disabled due to lack of power.

13. The vehicle of claim 12, wherein the pin comprises a proximity pilot pin.

14. The vehicle of claim 13, wherein the low voltage power for charging is 12 volts.

15. The vehicle of claim 12, wherein the recovery circuit module is disabled when an energy storage system reaches a threshold.

16. The vehicle of claim 12, wherein the BMS is configured to send instructions to a controller of an electrical vehicle supply equipment (EVSE) to provide high voltage direct current (HVDC) power to an energy storage system (ESS) of the vehicle.

17. The vehicle of claim 12, wherein the BMS is configured to enter into a recovery charging mode when activated by the recovery circuit module, wherein the BMS is configured to transmit instructions during the recovery charging mode to close contactors to enable an electrical vehicle supply equipment (EVSE) to provide high voltage direct current (HVDC) power to an energy storage system (ESS) of the vehicle.

18. A method for recovery of an electric vehicle, the method comprising:
receiving a power transmission for low voltage power for charging on a pin of a charging port of the electric vehicle;
detecting the power transmission by a recovery circuit;
providing the power to one or more of a battery management system (BMS), a DC fast charging (DCFC) contactor, a pre-charge contactor, or a main contactor based on detecting the power transmission by a recovery circuit; and
closing one or more of the contactors by the BMS to enable high voltage direct current (HVDC) power to be transmitted to an energy storage system (ESS).

19. The method of claim 18, wherein the pin comprises a proximity pilot pin.

20. The method of claim 19, further comprising:
sending a first signal to a control pilot pin, the first signal indicating a change in voltage sent through proximity pilot pin, wherein the change in voltage is from approximately 12V to approximately 5V; and
sending a second signal to the control pilot pin, the second signal indicating that a recovery electric vehicle supply equipment (EVSE) transmit the HVDC power to the ESS.
